(19) United States
(12) Patent Application Publication
(10) Pub. No.: US 2014/0239896 A1
(43) Pub. Date: Aug. 28, 2014

(54) CHARGE/DISCHARGE CONTROL CIRCUIT AND METHOD FOR CONTROLLING CHARGE/DISCHARGE

(71) Applicant: Junji TAKESHITA, Tokyo (JP)

(72) Inventor: Junji TAKESHITA, Tokyo (JP)

(73) Assignee: MITSUMI ELECTRIC CO., LTD., Tokyo (JP)

(21) Appl. No.: 14/182,373

(22) Filed: Feb. 18, 2014

(30) Foreign Application Priority Data
Feb. 28, 2013 (JP) 2013-038647

(51) Int. Cl. H02J 7/00

(52) U.S. Cl. CPC H02J 7/0024
USPC 320/117

(57) ABSTRACT

A charge/discharge control circuit for controlling charging and discharging of multiple secondary batteries includes a series-connection switch part that connects the multiple secondary batteries in series during the charging and connects the multiple secondary batteries in parallel during the discharging.

### BACKGROUND OF THE INVENTION

1. Field of the Invention

The present invention generally relates to a method and a circuit for controlling charging and discharging of multiple secondary batteries.

2. Description of the Related Art

In recent years, more functions have been provided to portable electronic devices such as smartphones and tablet-type terminals. Therefore, the amount of electric power consumed by the portable electronic devices is increasing. Thus, in order to extend the operation time of the portable electronic devices, there is a demand for increasing the battery capacity of the portable electronic devices.

Further, a charge/discharge control circuit for controlling charge/discharge of a secondary battery includes a protection IC configured as a semiconductor integrated circuit. For example, an over-charge voltage detection circuit, an over-discharge voltage detection circuit, a charge overcurrent detection circuit, and a discharge overcurrent detection circuit are installed in the protection IC. In a case where an over-discharge voltage is detected by the over-discharge detection circuit or a discharge overcurrent is detected by the discharge overcurrent detection circuit, discharging of a lithium ion battery is stopped by shutting off a MOS transistor for stopping the discharging of the lithium ion (discharge stoppage MOS transistor). Further, in a case where an overcharge voltage is detected by the overcharge detection circuit or a charge overcurrent is detected by the charge overcurrent detection circuit, charging of the lithium ion battery is stopped by shutting off a MOS transistor for stopping charging of the lithium ion (charge stoppage MOS transistor).

For example, Japanese Laid-Open Patent Publication No. 2007-250364 proposes a technology of charging two batteries by switching the methods for connecting the two batteries. That is, in a case of charging the two batteries, this technology may switch between a method of charging the two batteries separately (charging either one of the batteries) and a method of charging the two batteries by connecting the two batteries in series.

Conventionally, in a case where battery capacity of a secondary battery is increased, for example, by two times, the amount of current for charging the secondary battery increases two times. Due to the increase of the charge current, both the heat generated during the charging of the secondary battery and the width of the wiring (charge path) used for charging the secondary battery increase.

### SUMMARY OF THE INVENTION

The present invention may provide a method and a circuit for controlling charging and discharging of multiple secondary batteries that substantially obviate one or more of the problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by a method and a circuit for controlling charging and discharging of multiple secondary batteries particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides a charge/discharge control circuit for controlling charging and discharging multiple secondary batteries including a series-connection switch part that connects the multiple secondary batteries in series during the charging and connects the multiple secondary batteries in parallel during the discharging.

Other objects and further features of the present invention will be apparent from the following detailed description when read in conjunction with the accompanying drawings.

### BRIEF DESCRIPTION OF THE DRAWINGS

FIG. 1 is a block diagram illustrating a charge/discharge control circuit according to an embodiment of the present invention;

FIG. 2 is a circuit diagram illustrating a charge/discharge control circuit according to an embodiment of the present invention;

FIG. 3 is a block diagram illustrating a charge/discharge control circuit according to an embodiment of the present invention;

FIG. 4 is a circuit diagram illustrating a charge/discharge control circuit according to an embodiment of the present invention;

FIG. 5 is a signal timing chart indicating a timing for switching connection of battery cells according to an embodiment of the present invention;

FIG. 6 is a state transition diagram of a charge/discharge control circuit according to an embodiment of the present invention; and

FIG. 7 is a circuit diagram illustrating a modified example of a charge/discharge control circuit according to an embodiment of the present invention.

### DESCRIPTION OF THE PREFERRED EMBODIMENTS

In the following, embodiments of the present invention will be described with reference to the accompanying drawings.

### Embodiment of Charge/Discharge Control Circuit

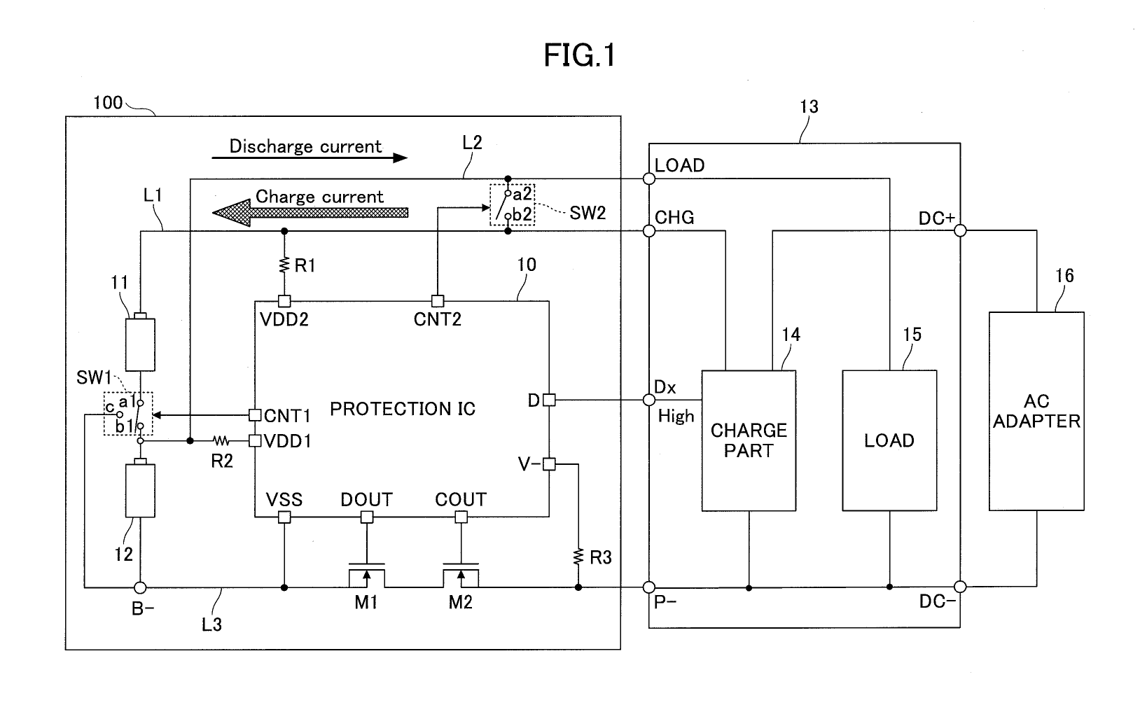

FIG. 1 is a block diagram illustrating a charge/discharge control circuit according to an embodiment of the present invention. In FIG. 1, the charge/discharge control circuit is configured as a semiconductor integrated circuit. The charge/discharge control circuit includes a protection IC (Integrated Circuit) 10. Battery cells 11 and 12 are provided outside the protection IC 10. In this embodiment, the battery cells 11, 12 are secondary batteries such as lithium ion batteries.

The cathode of the battery cell 11 is connected to a terminal VDD2 of the protection IC 10 from a first power source line L1 via a resistor R1. The cathode of the battery cell 11 is also connected to a first end “a2” of a switch SW2 provided inside a battery pack 100. Further, the cathode of the battery cell 11 is connected to a terminal CHG of the battery pack 100 (or an electronic device 13). The anode of the battery cell 11 is connected to a first end “a1” of a switch SW1 provided inside the battery pack 100. It is to be noted that FIG. 1 illustrates the state of the switches SW1, SW2 of the charge/discharge control circuit during the charging of the battery cells 11, 12.

The cathode of the battery cell 12 is connected to a second end “b1” of the switch SW1 provided inside the battery pack 100. Further, the cathode of the battery cell 12 is connected to a terminal VDD1 of the protection IC 10 via a resistor R2. Further, the cathode of the battery cell 12 is connected from a second power source line L2 to a second end “b2” of the switch SW2 provided inside the battery pack 100. Further, the cathode of the battery cell 12 is connected from the second power source line L2 to a terminal LOAD of the battery pack 100 (or the electronic device 13).

The anode of the battery cell 12 is connected to a third end “c” of the switch SW1 via a terminal “B−”. Further, the anode of the battery cell 12 is connected from a third power source line L3 to a terminal VSS of the protection circuit IC 10. Further, the anode of the battery cell 12 is connected to a terminal “P−” of the battery pack 100 (or the electronic device 13) via a n-channel MOS transistor M1 for cutting off discharge current (hereinafter also referred to as “discharge current cut-off n-channel MOS transistor M1”) and a re-channel MOS transistor M2 for cutting off charge current (hereinafter also referred to as “charge current cut-off n-channel MOS transistor M2”).

A control terminal of the switch SW1 is connected to a terminal CNT1 of the protection IC 10. A control terminal of the switch SW2 is connected to a terminal CNT2 of the protection IC 10. The terminal “P−” of the battery pack 100 is connected to a terminal “V−” of the protection IC 10 via a resistor R3. Further, a terminal D of the protection IC 10 is connected to a charge part 14 of the electronic device 13 via a terminal Dx of the battery pack 100 (or the electronic device 13).

The terminal LOAD of the electronic device 13 is connected to the cathode of a load 15. A terminal CHG of the electronic device 13 and a terminal “DC+” of the electronic device 13 are connected to the cathode of the charge part 14. The terminal “P−” of the electronic device 13 and a terminal “DC−” of the electronic device 13 are connected to the anode of the charge part 14 and the anode of the load 15. During the charging of the battery cells 11, 12, an AC adapter 16 is connected between the terminal “DC+” and the terminal “DC−” of the electronic device 13 for charging the battery cells 11, 12.

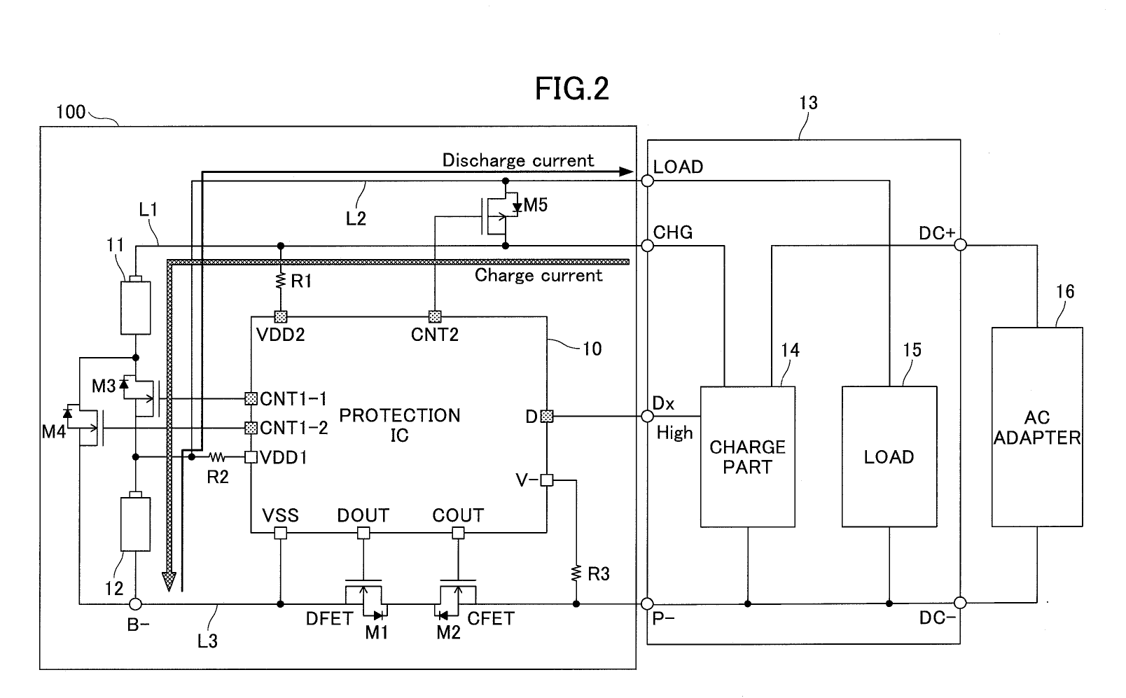

FIG. 2 is a circuit diagram illustrating a charge/discharge control circuit according to an embodiment of the present invention in a case where MOS transistors are used as the switches SW1, SW2 illustrated in FIG. 1. In FIG. 2, an n-channel MOS transistor M3 and an n-channel MOS transistor M4 constitute the switch SW1 of FIG. 1. A source of the n-channel MOS transistor M3 is connected to the cathode of the battery cell 12, a drain of the re-channel MOS transistor M3 is connected to the anode of the battery cell 11, and a gate of the n-channel MOS transistor M3 is connected to a terminal CNT1-1 of the protection IC 10. A source of the n-channel MOS transistor M4 is connected to the terminal “B−”, a drain of the n-channel MOS transistor M4 is connected to the anode of the battery cell 11, and a gate of the n-channel MOS transistor M4 is connected to a terminal CNT1-2 of the protection IC 10. The terminals CNT-1-1, CNT-1-2 correspond to the CNT1 of FIG. 1.

A p-channel MOS transistor M5 constitutes the switch SW2 of FIG. 1. A source of the p-channel MOS transistor M5 is connected to the terminal CHG of the electronic device 13, a drain of the p-channel MOS transistor M5 is connected to the terminal LOAD of the electronic device 13, and a gate of the p-channel MOS transistor M5 is connected to the terminal CNT2 of the protection IC 10. Each of the MOS transistors M3-M5 illustrated in FIG. 2 includes a parasitic diode between its gate and its drain.

### <Protection IC>

The protection IC 10 operates by being supplied with electric power via terminals VDD1, VDD2 and the terminal VSS. A terminal DOUT of the protection IC 10 is connected to the gate of the MOS transistor M1, and a terminal COUT of the protection IC 10 is connected to the gate of the MOS transistor M2. In a case of stopping the discharging of the battery cells 11, 12, the protection IC 10 switches off the MOS transistor M1. In a case of stopping the charging of the battery cells 11, 12, the protection IC 10 switches off the MOS transistor M2.

The protection IC 10 has, for example, an overcharge voltage detection circuit, an over-discharge voltage detection circuit, a charge overcurrent detection circuit, a discharge overcurrent detection circuit, a short-circuit detection circuit, an oscillator, a logic circuit, and a time shortening circuit installed therein.

The overcharge voltage detection circuit compares a cell voltage between the terminal VDD1 and the terminal VSS or a cell voltage between the terminal VDD2 and the terminal VDD1 with respect to a reference voltage Vdet1. In a case where the cell voltage between the terminal VDD1 and the terminal VSS or the cell voltage between the terminal VDD2 and the terminal VDD1 is higher than the reference voltage Vdet1, the overcharge voltage detection circuit generates an overcharge voltage detection signal and supplies the overcharge voltage detection signal to the oscillator and the logic circuit.

The over-discharge voltage detection circuit compares a cell voltage between the terminal VDD1 and the terminal VSS or a cell voltage between the terminal VDD2 and the terminal VDD1 with respect to a reference voltage Vdet2. In a case where the cell voltage between the terminal VDD1 and the terminal VSS or the cell voltage between the terminal VDD2 and the terminal VDD1 is lower than the reference voltage Vdet2, the over-discharge voltage detection circuit generates an over-discharge voltage detection signal and supplies the over-discharge voltage detection signal to the oscillator and the logic circuit.

The charge overcurrent detection circuit compares the voltage of the terminal “V−” and a reference voltage Vdet4. In a case where the voltage of the terminal “V−” is lower than the reference voltage Vdet4, the charge overcurrent detection circuit generates a charge overcurrent detection signal and supplies the charge overcurrent detection signal to the oscillator and the logic circuit.

The discharge overcurrent detection circuit compares the voltage of the terminal “V−” and a reference voltage Vdet3. In a case where the voltage of the terminal “V−” is higher than the reference voltage Vdet3, the discharge overcurrent detection circuit generates a discharge overcurrent detection signal and supplies the discharge overcurrent detection signal to the oscillator and the logic circuit.

The short circuit detection circuit compares the voltage of the terminal “V−” and a reference voltage Vshort. In a case where the voltage of the terminal “V−” is higher than the reference voltage Vshort, the short circuit detection circuit generates a short circuit detection signal. The short circuit detection signal may be supplied to the logic circuit by way of, for example, a delay circuit that is set with a predetermined delay time.

In a case where the overcharge voltage detection signal, the over-discharge voltage detection signal, the charge overcurrent detection signal, or the discharge overcurrent detection signal is supplied to the oscillator, oscillation of the oscillator is initiated. Thereby, the oscillator generates a clock signal and supplies the clock signal to the logic circuit.

The logic circuit includes a counter and a status register. The logic circuit uses the counter to count the time (clock pulse) in which the overcharge voltage detection signal is supplied thereto. In a case where the counted time surpasses a predetermined time, the logic circuit retains (stores) an overcharge voltage detection status in the status register, switches off the MOS transistor M2 by setting the terminal COUT to a low level (value 0), and switches on the MOS transistor M1 by setting the terminal DOUT to a high level (value 1).

Further, the logic circuit uses the counter to count the time (clock pulse) in which the over-discharge voltage detection signal is supplied thereto. In a case where the counted time surpasses a predetermined time, the logic circuit retains (stores) an over-discharge voltage detection status in the status register, switches on the MOS transistor M2 by setting the terminal COUT to a high level, and switches off the MOS transistor M1 by setting the terminal DOUT to a low level.

Further, the logic circuit uses the counter to count the time (clock pulse) in which the charge overcurrent detection signal is supplied thereto. In a case where the counted time surpasses a predetermined time, the logic circuit retains (stores) a charge overcurrent detection status in the status register, switches off the MOS transistor M2 by setting the terminal COUT to a low level, and switches on the MOS transistor M1 by setting the terminal DOUT to a high level.

Further, the logic circuit uses the counter to count the time (clock pulse) in which the discharge overcurrent detection signal is supplied thereto. In a case where the counted time surpasses a predetermined time, the logic circuit retains (stores) a discharge overcurrent detection status in the status register, switches on the MOS transistor M2 by setting the terminal COUT to a high level, and switches off the MOS transistor M1 by setting the terminal DOUT to a low level.

Further, in a case where the short-circuit detection signal is supplied to the logic circuit, the logic circuit retains (stores) a short-circuit detection status in the status register, switches on the MOS transistor M2 by setting the terminal COUT to a high level, and switches off the MOS transistor M1 by setting the terminal DOUT to a low level.

### <Charge State>

During the charging of the battery cells 11, 12, the charge part 14 supplies a high level control signal(s) to the terminal D of the protection IC 10, as illustrated in FIGS. 1 and 2. The protection IC 10 connects the battery cells 11, 12 in series by switching on the MOS transistor M3 and switching off the MOS transistor M4. Further, the protection IC 10 disconnects the connection between the terminal CHG of the electronic device 13 and the terminal LOAD of the electronic device 13 by switching off the MOS transistor M5. Further, the protection IC 10 switches on the MOS transistors M1 and M2.

Thereby, a charge current, which is supplied from the cathode of the charge part 14, flows from the terminal CHG of the electronic device 13, passes through the series-connected battery cells 11, 12 via the first power source line L1, and reaches the anode of the charge part 14. For example, when the charge current is 2.5 Ah in a case where each of the battery cells 11, 12 has a voltage of 4.2 V, the electric power supplied to the battery cells 11, 12 is 21 Wh (=2.5 Ah×8.4 V).

Even during the charging of the battery cells 11, 12, a current (discharge current of the battery cell 12) from the cathode of the battery cell 12 may pass through the terminal LOAD of the electronic terminal 13 via the second power line L2 and reach the load 15.

### <Discharge State>

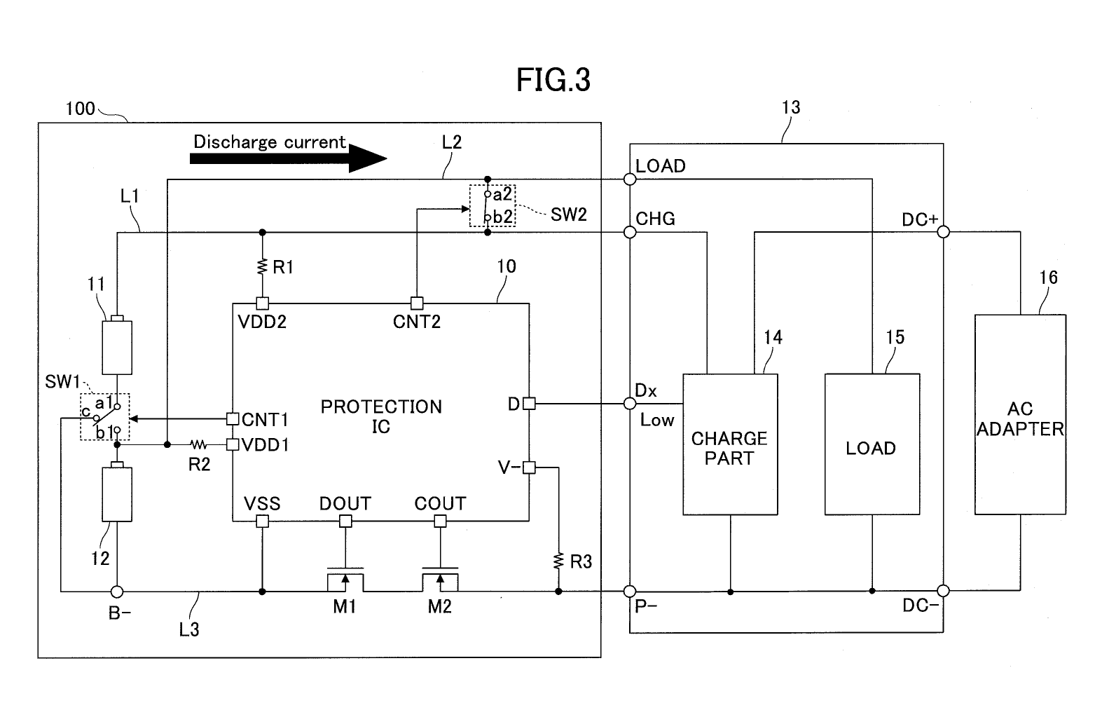

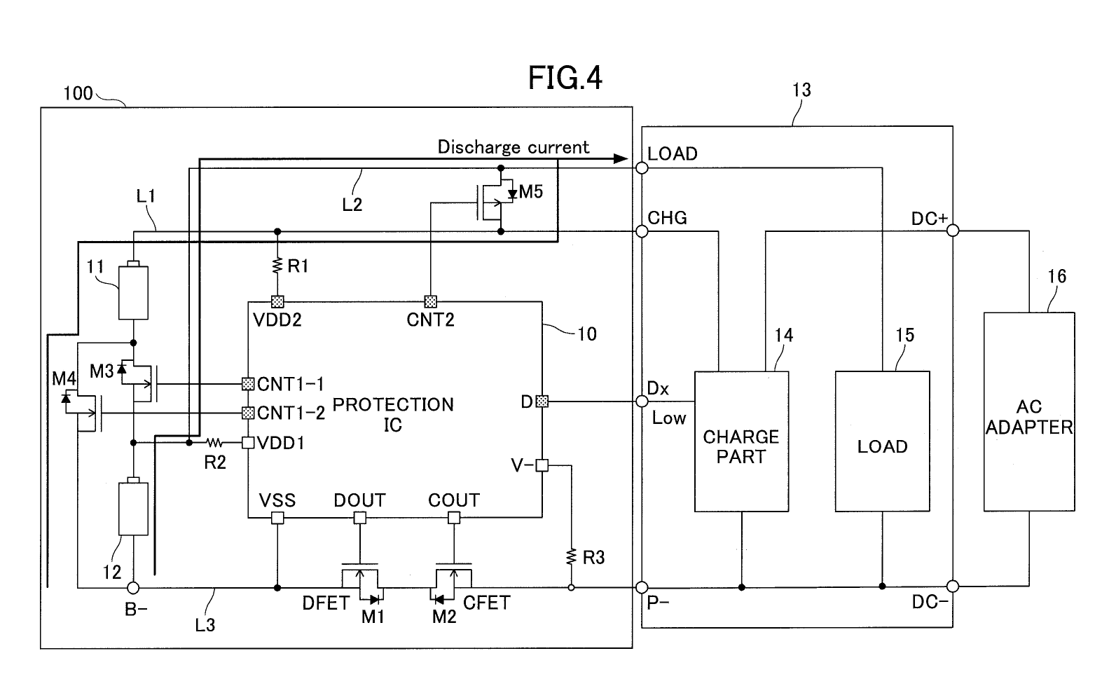

FIG. 3 is a block diagram illustrating a charge/discharge control circuit according to an embodiment of the present invention for describing the state of the switches SW1, SW2 during the discharging of the battery cells 11, 12. FIG. 4 is a circuit diagram illustrating a charge/discharge control circuit according to an embodiment of the present invention in a case where MOS transistors are used as the switches SW1, SW2 illustrated in FIG. 3.

During the discharging of the battery cells 11, 12, the charge part 14 supplies a low level control signal(s) to the terminal D of the protection IC 10 as illustrated in FIGS. 3 and 4. The protection IC 10 connects the battery cells 11, 12 in parallel by switching off the MOS transistor M3 and switching on the MOS transistor M4. Further, the protection IC 10 short-circuits the connection between the terminal CHG of the electronic device 13 and the terminal LOAD of the electronic device 13 by switching on the MOS transistor M5. Further, the protection IC 10 switches on the MOS transistors M1 and M2.

Thereby, currents (discharge currents of the battery cells 11, 12), which are supplied from the cathodes of the battery cells 11, 12, flow from the terminal LOAD of the electronic device 13, pass through the load 15, and reach the anodes of the battery cells 11, 12. For example, when the charge current is 2.5 Ah in a case where each of the battery cells 11, 12 has a voltage of 4.2 V, the electric power supplied to the load 15 is 21 Wh (=5 Ah×4.2 V).

Accordingly, the battery capacity can be doubled (increased two times) by switching the connection of the battery cells 11, 12 to parallel connection during the discharging of the battery cells 11, 12. By switching the connection of the battery cells 11, 12 to series connection during the charging of the battery cells 11, 12, the charge current can become equivalent to the charge current for a single battery cell.

### <Switching of Connection>

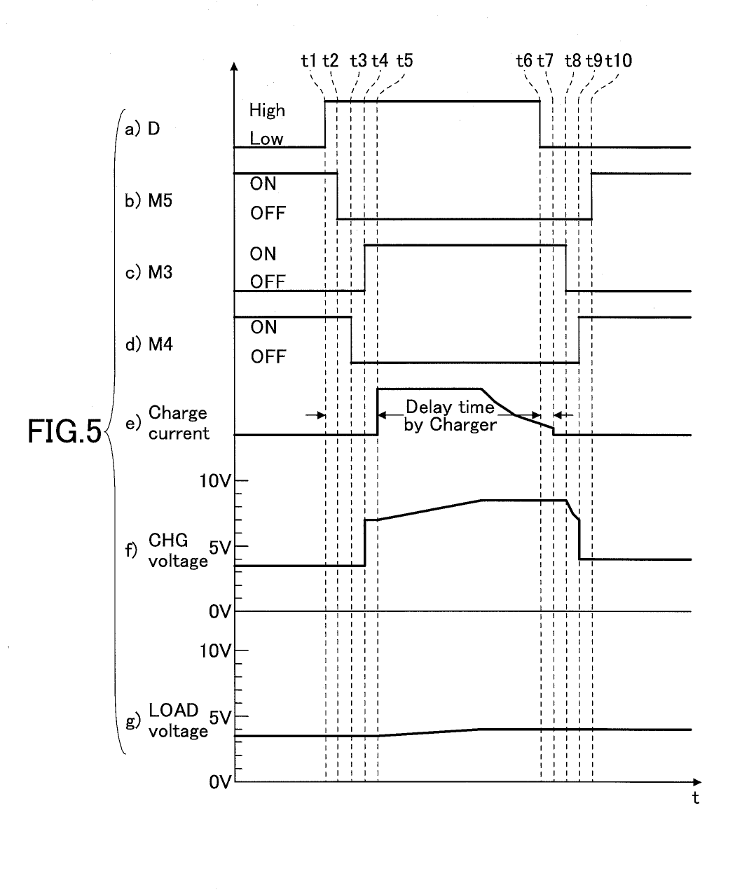

FIG. 5 is a signal timing chart indicating the timing for switching the connection of the battery cells 11, 12. As illustrated in a) of FIG. 5, a control signal supplied from the charge part 14 to the terminal D of the protection IC 10 switches from low level to high level at timing t1. This initiates a process of switching the connection of the battery cells 11, 12 from parallel connection to series connection. In order to prevent malfunction due to external noise, a delay time (t2−t1) is set to, for example, a delay circuit provided in the protection IC 10.

As illustrated in b) of FIG. 5, the MOS transistor M5 is switched off by switching the gate of the MOS transistor M5 to a low level at timing t2. Thereby, a discharge path from the battery cell 11 is disconnected.

In order to separate a low electric potential side of the battery cell 11 from the terminal “B−”, the MOS transistor M4 is switched off by switching the gate of the MOS transistor M4 to a low level at timing t3 as illustrated in d) of FIG. 5. Further, in order to connect the low electric potential side of the battery cell 11 to a high electric potential side of the battery cell 12, the MOS transistor M3 is switched on by switching the gate of the MOS transistor M3 to a high level at timing t4 as illustrated in c) of FIG. 5.

After completing the process of switching the connection of the battery cells 11, 12 from a parallel connection to a series connection, the charge part 14 begins charging the battery cells 11, 12 at timing t5. The charge current flowing in the battery cells 11, 12 is illustrated in e) of FIG. 5.

Further, the voltage of the terminal CHG of the protection IC 10 is illustrated in f) of FIG. 5. The voltage of the terminal LOAD of the protection IC 10 is illustrated in g) of FIG. 5.

The control signal illustrated in a) of FIG. 5 switches from a high level to a low level at timing t6. This initiates a process of switching the connection of the battery cells 11, 12 from a series connection to a parallel connection. In order to prevent malfunction due to external noise, a delay time (t8−t6) is set to, for example, a delay circuit provided in the protection IC 10.

As illustrated in e) of FIG. 5, the charge part 14 stops charging at timing t7. A delay time (t7−t6) is set to, for example, a delay circuit in the protection IC 10 until the charge part 14 stops charging. In order to release the series connection of the battery cells 11, 12, the MOS transistor M3 at the low electric potential side of the battery cell 11 is switched off at timing t8 as illustrated in c) of FIG. 5.

In order to connect the lower electric potential side of the battery cell 11 to the terminal “B−”, the MOS transistor M4 is switched on at timing t9 as illustrated in d) of FIG. 5. After switching the connection of the battery cells 11, 12 from a series connection to a parallel connection, the MOS transistor M5 is switched on at timing t10. Thereby, in addition to the discharging by the battery cell 12, the battery cell 11 begins discharging.

### <Transition of the State of the Charge/Discharge Control Circuit>

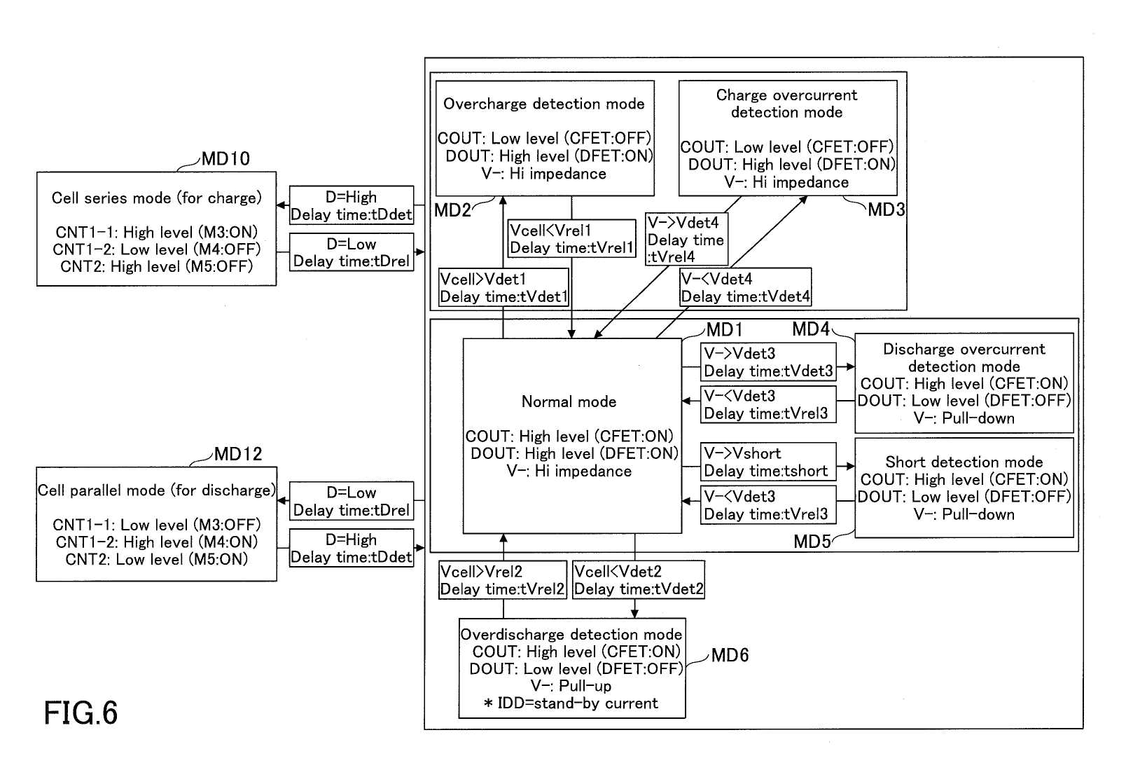

FIG. 6 is a state transition diagram of a charge/discharge control circuit according to an embodiment of the present invention. In a normal mode state MD1, high level signals are supplied to the gates of the MOS transistors M1, M2, so that both the MOS transistors M1, M2 are switched on.

In the normal mode state MD1, voltage Vcell is compared with the overcharge detection voltage Vdet1. The voltage Vcell corresponds to the voltage on both ends of each battery cell 11, 12 (i.e. voltage between VDD1 and VSS or voltage between VDD2 and VDD1). In a case where the state of Vcell>Vdet1 continues for more than a predetermined time tVdet1, the state of the charge/discharge control circuit shifts to an overcharge voltage detection state MD2. In the overcharge voltage detection state MD2, the MOS transistor M1 is switched on whereas the MOS transistor M2 is switched off. Then, in a case where the state of the Vcell<Vre1 continues for more than a predetermined time tVrel1, the state of the charge/discharge control circuit shifts to the normal mode state MD1. It is to be noted that “Vre1” (<Vdet1) indicates a recovery reference voltage.

Further, in the normal mode state MD1, the voltage Vcell is compared with the over-discharge detection voltage Vdet2. In a case where the state of Vcell<Vdet2 continues for more than a predetermined time tVdet2, the state of the charge/discharge control circuit shifts to an over-discharge voltage detection state MD6. In the over-discharge voltage detection state MD6, the MOS transistor M1 is switched off whereas the MOS transistor M2 is switched on. Then, in a case where the state of Vcell>Vrel2 continues for more than a predetermined time tVrel2, the state of the charge/discharge control circuit shifts to the normal mode state MD1. It is to be noted that “Vrel2” (>Vdet2) indicates a recovery reference voltage.

Further, in the normal mode state MD1, the voltage “V−” of the terminal “V−” is compared with the charge overcurrent detection voltage Vdet4. In a case where the state of V−<Vdet4 continues for more than a predetermined time tVdet4, the state of the charge/discharge control circuit shifts to a charge overcurrent detection state MD3. In the charge overcurrent detection state MD3, the MOS transistor M1 is switched on whereas the MOS transistor M2 is switched off. Then, in a case where the state of V−>Vdet4 continues for more than a predetermined time tVrel4, the state of the charge/discharge control circuit shifts to the normal mode state MD1.

Further, in the normal mode state MD1, the voltage “V−” of the terminal “V−” is compared with the discharge overcurrent detection voltage Vdet3.

In a case where the state of V−>Vdet3 continues for more than a predetermined time tVdet3, the state of the charge/discharge control circuit shifts to a discharge overcurrent detection state MD4. In the discharge overcurrent detection state MD4, the MOS transistor M1 is switched off whereas the MOS transistor M2 is switched on. Then, in a case where the state of V−<Vrel3 continues for more than a predetermined time tVrel3, the state of the charge/discharge control circuit shifts to the normal mode state MD1.

Further, in the normal mode state MD1, the voltage “V−” of the terminal “V−” is compared with the short-circuit detection voltage Vshort. In a case where the state of V−>Vshort continues for more than a predetermined time tVshort, the state of the charge/discharge control circuit shifts to a short-circuit detection state MD5. In the short-circuit detection state MD5, the MOS transistor M1 is switched off whereas the MOS transistor M2 is switched on. Then, in a case where the state of V−<Vdet3 continues for more than a predetermined time tVrel3, the state of the charge/discharge control circuit shifts to the normal mode state MD1.

Further, in the normal mode state MD1, the charge/discharge control circuit shifts to a cell series mode state MD10 in a case where the charge part 14 continues to supply high level control signals (D=High) to the terminal D of the protection IC 10 for more than a predetermined time tDdet. In the cell series mode state MD10, the MOS transistor M3 is switched on, the MOS transistor M4 is switched off, and the MOS transistor M5 is switched off.

Further, in a case where the charge part 14 continues to supply low level control signals (D=Low) for more than a predetermined time tDrel in the cell series mode state MD10, the charge/discharge control circuit shifts to the normal mode state MD1, and then shifts to a cell parallel mode state MD12. In the cell parallel mode state MD12, the MOS transistor M3 is switched off, the MOS transistor M4 is switched on, and the MOS transistor M5 is switched on.

### MODIFIED EXAMPLE

In the charge/discharge control circuit according to the above-described embodiment of the present invention, the process of switching between parallel connection and series connection is performed with two battery cells 11, 12. However, the process of switching between parallel connection and series connection may also be performed with three or more battery cells. Accordingly, a charge/discharge control circuit that performs the process of switching between parallel connection and series connection on three battery cells is described below.

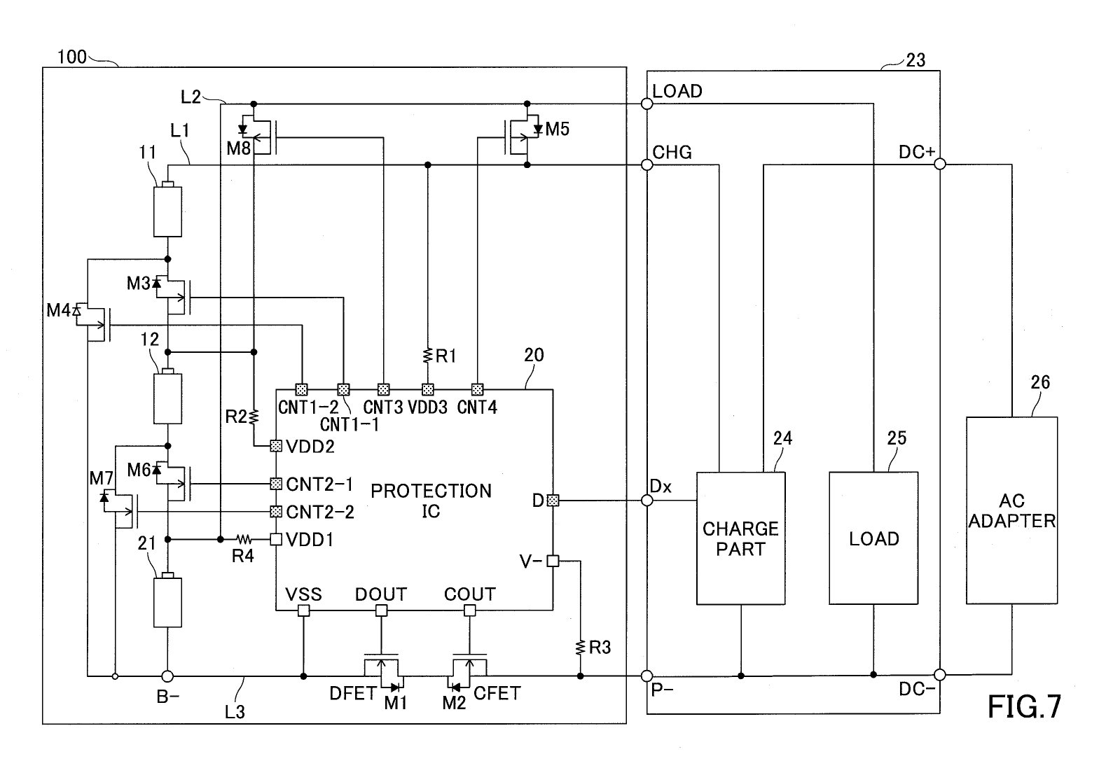

FIG. 7 is a circuit diagram illustrating a modified example of a charge/discharge control circuit according to an embodiment of the present invention. In the description of the modified example, like components are denoted with like reference numerals as those of the above-described embodiment and are not further explained. In FIG. 7, the charge/discharge control circuit is configured as a semiconductor integrated circuit and includes a protection IC (Integrated Circuit) 20. Battery cells 11, 12, and 21 are provided outside the protection IC 20. In this embodiment, the battery cells 11, 12, and 21 are secondary batteries such as lithium ion batteries.

The cathode of the battery cell 11 is connected to a terminal VDD3 of the protection IC 20 from the first power source line L1 via the resistor R1. The cathode of the battery cell 11 is also connected to a source of the p-channel MOS transistor M5 provided in the battery pack 100. Further, the cathode of the battery cell 11 is connected to the terminal CHG of the battery pack 100 (or an electronic device 23). The anode of the battery cell 11 is connected to the drain of the re-channel MOS transistor M3 and the drain of the re-channel MOS transistor M4 that are provided in the battery pack 100.

The cathode of the battery cell 12 is connected to the source of the MOS transistor M3 provided in the battery pack 100. Further, the cathode of the battery cell 12 is connected to the terminal VDD2 of the protection IC 20 via the resistor R2. Further, the cathode of the battery cell 12 is connected to the source of the p-channel MOS transistor M8 provided in the battery pack 100. The anode of the battery cell 12 is connected to the drain of the n-channel MOS transistor M6 and the drain of the n-channel MOS transistor M7 provided in the battery pack 100.

The cathode of the battery cell 21 is connected to the source of the MOS transistor M6 provided in the battery pack 100. Further, the cathode of the battery cell 21 is connected to the terminal VDD1 of the protection IC 20 via the resistor R4. Further, the cathode of the battery cell 21 is connected from the second power source line L2 to the drain of the MOS transistor M8 and the drain of the MOS transistor M5 provided in the battery pack 100. Further, the cathode of the battery cell 21 is connected from the second power source line L2 to the terminal LOAD of the battery pack 100 (or the electronic device 23).

The anode of the battery cell 21 is connected to the source of the MOS transistor M4 and the source of the MOS transistor M7 via the terminal “B−”. Further, the anode of the battery cell 21 is connected from a third power source line L3 to the terminal VSS of the protection IC 20. Further, the anode of the battery cell 21 is connected to the terminal “P−” of the battery pack 100 (or the electronic device 23) via the current cut-off re-channel MOS transistor M1 and the current cut-off re-channel MOS transistor M2.

The gate of the MOS transistor M3 is connected to a terminal CNT1-1 of the protection IC 20. The gate of the MOS transistor M4 is connected to a terminal CNT1-2 of the protection IC 20. The gate of the MOS transistor M6 is connected to a terminal CNT2-1 of the protection IC 20. The gate of the MOS transistor M7 is connected to a terminal CNT2-2 of the protection IC 20. The gate of the MOS transistor M8 is connected to a terminal CNT3 of the protection IC 20.

The terminal “P−” of the battery pack 100 is connected to the terminal “V−” of the protection IC 20 via the resistor R3. Further, the terminal D of the protection IC 20 is connected to the charge part 24 of the electronic device 24 via the terminal Dx of the battery pack 100 (or the electronic device. 23).

The terminal LOAD of the electronic device 23 is connected to the cathode of the load 25. The terminal CHG of the electronic device 23 and the terminal “DC+” of the terminal device 23 are connected to the cathode of the charge part 24. The terminal “P−” of the electronic device 23 and the terminal “DC−” of the electronic device 23 are connected to the anode of the charge part 24 and the anode of the load 25. During the charging of the battery cells 11, 12, 21, an AC adapter 26 is connected between the terminal “DC+” and the terminal “DC−” of the electronic device 23 for charging the battery cells 11, 12, and 21.

### <Charge State>

During the charging of the battery cells 11, 12, and 21, the charge part 24 supplies a high level control signal(s) to the terminal D of the protection IC 20. Thereby, the protection IC 20 connects the battery cells 11, 12, and 21 in series by switching on the MOS transistors M3, M6 and switching off the MOS transistors M4, M7. Further, the protection IC 20 disconnects the connection between the terminal CHG of the electronic device 23 and the terminal LOAD of the electronic device 23 by switching off the MOS transistor M5. Further, the protection IC 20 disconnects the connection between the terminal LOAD of the electronic device 23 and the cathode of the battery cell 12 by switching off the MOS transistor M8. Further, the protection IC 20 switches on the MOS transistors M1, M2.

Thereby, a charge current, which is supplied from the cathode of the charge part 24, flows from the terminal CHG of the electronic device 23, passes through the series-connected battery cells 11, 12, 21 via the first power source line L1, and reaches the anode of the charge part 24. For example, when the charge current is 2.5 Ah in a case where each of the battery cells 11, 12, 21 has a voltage of 4.2 V, the electric power supplied to each of the battery cells 11, 12, 21 is 31.5 Wh (=2.5 Ah×12.6 V).

Even during the charging of the battery cells 11, 12, and 21, a current (discharge current of the battery cell 21) from the cathode of the battery cell 21 may pass through the terminal LOAD of the electronic terminal 23 via the second power line L2 and reach the load 25.

### <Discharge State>

During the discharging of the battery cells 11, 12, and 21, the charge part 24 supplies a low level control signal(s) to the terminal D of the protection IC 20. Thereby, the protection IC 20 connects the battery cells 11, 12, and 21 in parallel by switching off the MOS transistors M3, M6 and switching on the MOS transistors M4, M7. Further, the protection IC 20 short-circuits the connection between the terminal CHG of the electronic device 23 and the terminal LOAD of the electronic device 23 by switching on the MOS transistor M5. Further, the protection IC 20 connects the terminal LOAD of the electronic device 23 and the cathode of the battery cell 12. Further, the protection IC 20 switches on the MOS transistors M1 and M2.

Thereby, currents (discharge currents of the battery cells 11, 12, and 21), which are supplied from the cathodes of the battery cells 11, 12, and 21, flow from the terminal LOAD of the electronic device 23, pass through the load 25, and reach the anodes of the battery cells 11, 12, and 21. For example, when the charge current is 2.5 Ah in a case where each of the battery cells 11, 12, and 21 has a voltage of 4.2 V, the electric power supplied to the load 25 is 31.5 Wh (=7.5 Ah×4.2 V).

Further, the present invention is not limited to these embodiments, but variations and modifications may be made without departing from the scope of the present invention.

The present application is based on and claims the benefit of priority of Japanese Priority Application No. 2013-038647 filed on Feb. 28, 2013, with the Japanese Patent Office, the entire contents of which are hereby incorporated by reference.

What is claimed is:

1. A charge/discharge control circuit for controlling charging and discharging of a plurality of secondary batteries, the charge/discharge control circuit comprising:
a series-connection switch part configured to connect the plurality of secondary batteries in series during the charging and connect the plurality of secondary batteries in parallel during the discharging.

2. The charge/discharge control circuit as claimed in claim 1, further comprising:
a charge line through which a charge current flows for charging the plurality of secondary batteries;
a discharge line through which a discharge current flows for discharging the plurality of secondary batteries; and
a disconnection/short-circuit switch part configured to disconnect a connection between the charge line and the discharge line during the charging and short-circuit the connection between the charge line and the discharge line during the discharging.

3. A method for controlling charging and discharging of a plurality of secondary batteries, the charge/discharge control circuit comprising the steps of:
connecting the plurality of secondary batteries in series during the charging; and
connecting the plurality of secondary batteries in parallel during the discharging.

4. The method as claimed in claim 3, further comprising the steps of:
disconnecting a connection between a charge line through which a charge current flows for charging the plurality of secondary batteries and a discharge line through which a discharge current flows for discharging the plurality of secondary batteries, during the charging; and
short-circuiting the connection between the charge line and the discharge line during the discharging.
